(19) United States
(12) Patent Application Publication
(10) Pub. No.: US 2018/0304383 A1
(43) Pub. Date: Oct. 25, 2018

(54) CHOP SAW WITH IMPROVED MOTOR CONTROLS

(71) Applicant: Black & Decker Inc., New Britain, CT (US)

(72) Inventors: David C. Tomayko, Ellicott City, MD (US); Qiang Zhang, Lutherville, MD (US); William D. Spencer, Ellicott City, MD (US); John D. Cox, Lutherville, MD (US)

(21) Appl. No.: 15/769,371

(22) PCT Filed: Oct. 27, 2016
(86) PCT No.: PCT/US16/59124

§ 371 Date: Apr. 19, 2018

Related U.S. Application Data
(60) Provisional application No. 62/246,648, filed on Oct. 27, 2015.

(51) Int. Cl. B23D 45/04; B23D 59/00

(52) U.S. Cl. CPC B23D 45/042; G01D 5/16; B23D 59/002

(57) ABSTRACT

A chop saw has a base assembly, a support housing connected to the base assembly, a saw assembly pivotally connected to the support housing allowing the saw assembly to be pivoted downwardly towards the base assembly for conducting a cutting operation on a workpiece. The saw assembly has a motor, a blade driven by the motor and an upper blade guard for covering an upper portion of the blade. A sensor assembly senses a position of the saw assembly relative to the workpiece and/or the support housing. A controller receives a signal an input representative of the position of the saw assembly from the sensor assembly and controls the motor according to such signal.

### FIELD OF THE INVENTION

The present invention relates to chop saws, and in particular, to a chop saw with an improved motor control.

### BACKGROUND

Chop saws and miter saws are commonly found on jobsites because of their versatility and ability to make cuts that other power tools cannot make quickly. Typically a chop saw has a base assembly and a saw assembly attached to the base that can be lowered into a cutting position. One such chop saw illustrated in U.S. Pat. Nos. 6,272,960 and 8,607,678, which are fully incorporated herein by reference.

Referring to FIGS. 1-2, a chop saw 100 typically has a base assembly 10, a support housing 30 connected to the base assembly 10, and a saw assembly 40 pivotally connected to the support housing 30. If the chop saw 100 is a miter saw, base assembly 10 would comprise a rotatable table assembly 20 rotatably attached to the base assembly 10, and support housing 30 would be connected the table assembly 20. The saw assembly 40 may include an arm 41 pivotally connected to support housing 30, an upper blade guard 42 connected to arm 41, a motor 45 supported by arm 41 and/or upper blade guard 42, a blade 43 driven by the motor 45, and a lower blade guard 44 pivotally attached to the upper blade guard.

A fence assembly 15 is typically attached to base assembly 10. With such construction, a user can place a work piece against fence assembly 15 and table assembly 20 for cutting. The user can make a miter cut by rotating table assembly 20 relative to base assembly 10.

If support housing 30 is pivotally attached to table assembly 20, the user can rotate support housing 30 relative to table assembly 20 and/or base assembly 10, tilting the blade 43 relative to the table assembly 20, thus changing the blade's bevel angle. A cut made with the blade 43 tilted at an angle (and perpendicular to the fence assembly 15) is known as a “bevel cut.” A cut made with the blade 43 set to both an angle relative to the fence assembly 15 (miter angle) and an angle relative to the base assembly 10 (bevel angle) is known as a “compound cut.”

It is well known that the motor 45 may be powered by a rechargeable power tool battery pack 46. An exemplary arrangement is shown in U.S. Pat. No. 6,763,751, which is hereby incorporated by reference. Battery pack 46 is preferably mounted on motor housing 45H and/or handle 47, which may be attached to upper blade guard 42 and/or arm 41.

An on/off switch 45S provided on handle 47 allows the user to control when electric power is provided to motor 45. Such switch 45S allows the user to turn on and off motor 45 (causing blade 43 to rotate) by pressing and releasing switch 45S, respectively.

It is desirable to control motor 45 to maximize the number of cuts that can be performed by chop saw 100 without requiring disconnecting battery pack 46 from chop saw 100 for recharging.

### BRIEF DESCRIPTION OF THE DRAWINGS

FIG. 1 is a front left perspective view of a miter saw.

FIG. 2 is a rear view of the miter saw of FIG. 1.

FIG. 3 is a block diagram of the motor control system according to the invention.

FIG. 4 is a side view of a first embodiment of a position sensor.

FIG. 5 is a side view of a second embodiment of a position sensor.

FIG. 6 is a side view of a third embodiment of a position sensor.

FIG. 7 is a side view of a fourth embodiment of a position sensor.

FIG. 8 is a side view of a fifth embodiment of a position sensor.

FIG. 9 is a chart showing different maximum blade speeds at different positions of the saw assembly.

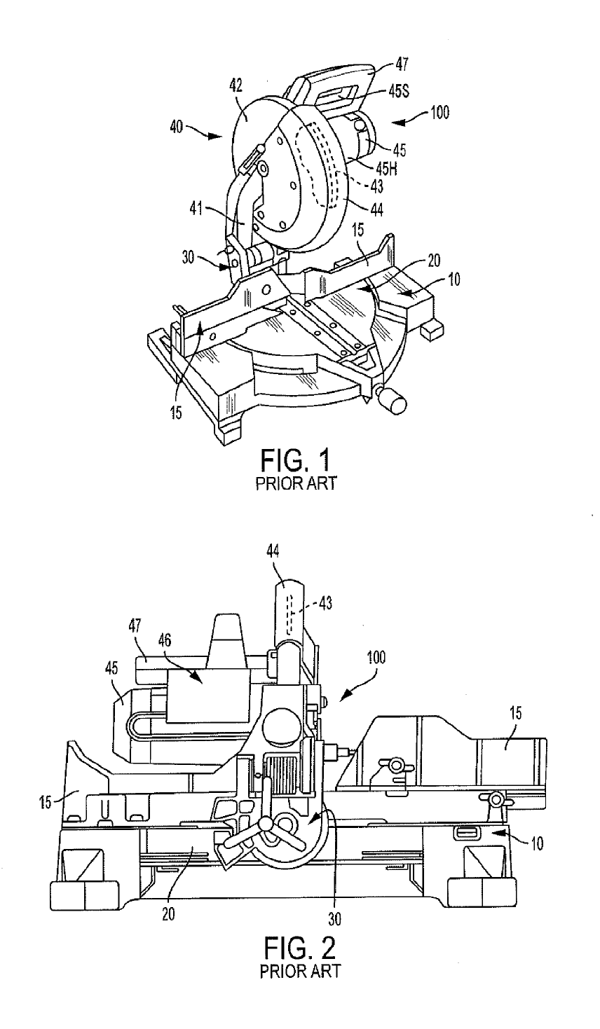

### DESCRIPTION

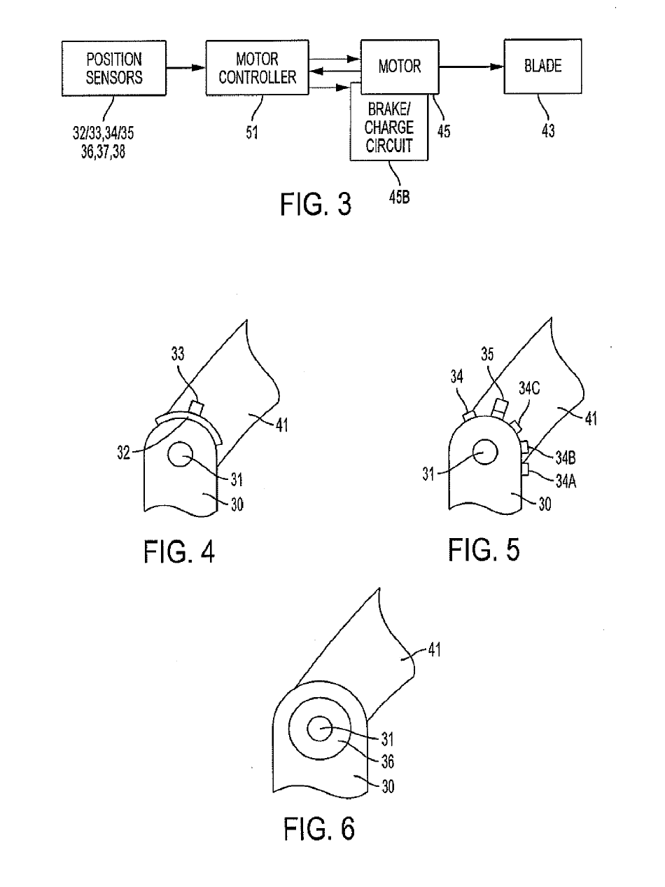

FIG. 3 illustrates the motor control system provided for chop saw 100 according to the invention. Motor controller 51 receives inputs from at least one position sensor 32/33, 34/35, 36, 37 and/or 38. Such position sensor(s) effectively senses the position of the blade 43 relative to the table assembly 20 and/or base assembly 10. Motor controller 51 controls the speed of motor 45 (and thus of blade 43) at least partly dependent upon the output of position sensor(s) 32/33, 34/35, 36, 37 and/or 38. Motor controller 51 may also receive a feedback signal representative of the speed of motor 45 to further control the motor speed.

FIG. 4 illustrates a first embodiment of the position sensor 32/33. In such embodiment, a resistive element 32 is disposed on the support housing 30. The arm 41 has a wiper 33 contacting the resistive element 32. Persons skilled in the art will recognize that such arrangement effectively creates a potentiometer, which can provide a signal representative of the angular position of arm 41 relative to support housing 30, thus providing an indication of the location of blade 43 relative to table assembly 20 and/or base assembly 10. Persons skilled in the art will recognize that resistive element 32 and wiper 33 may be provided alternatively on arm 41 and support housing 30, respectively.

FIG. 5 illustrates a second embodiment of the position sensor 34/35. In such embodiment, a plurality of switches 34 has been provided on support housing 30. Arm 41 has a protrusion 35 that contacts each individual switch 34, closing such switch 34, as arm 41 is rotated relative to support housing 30.

Persons skilled in the art will recognize that motor controller 51 can determine the angular position of arm 41 relative to support housing 30, thus providing an indication of the location of blade 43 relative to table assembly 20 and/or base assembly 10, according to which switch 34 has been closed. Persons skilled in the art will also recognize that switches 34 and protrusion 35 may be provided alternatively on arm 41 and support housing 30, respectively.

Preferably switches 34 are placed at the different positions that are desirable to detect. Persons skilled in the art will recognize the number of switches 34 may be determined by the number of positions that are desirable to detect, and that, if a larger number of switches 34 is utilized, the rotational position of arm 41 can be detected with more granularity and thus more certainty thereof.

FIG. 6 illustrates a third embodiment of the position sensor 36. In such embodiment, a rotary encoder 36 is provided on support housing 30. As arm 41 is rotated relative to support housing 30, axle 31 may rotate therealong. Rotary encoder 36 would detect such rotation and provide a signal representative of the rotational motion of axle 31 (and thus of arm 41). Preferably rotary encoder 36 is an absolute rotary encoder.

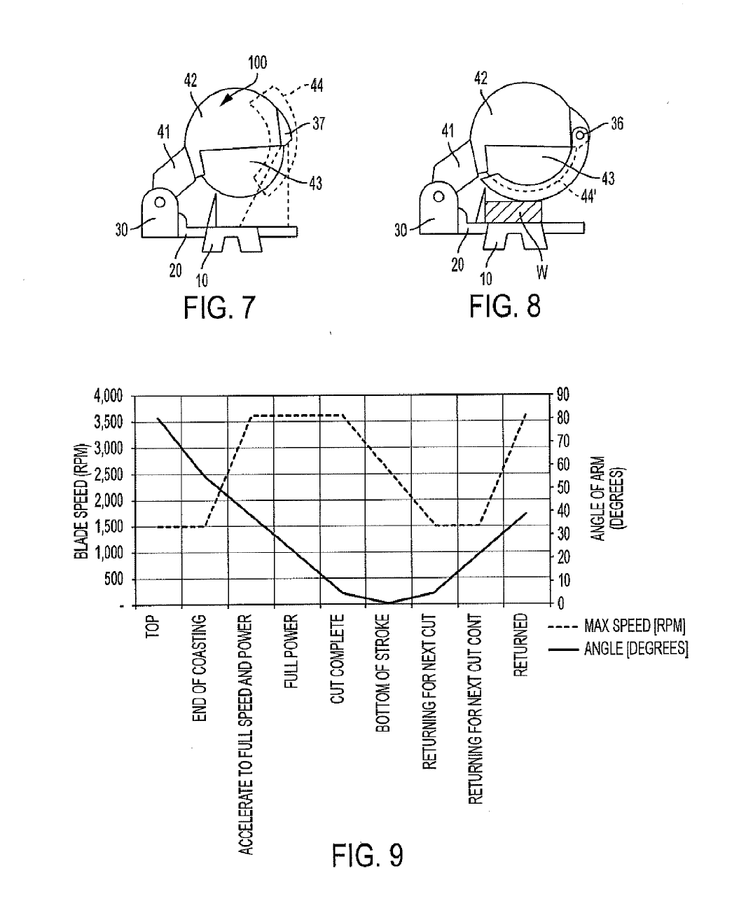

FIG. 7 illustrates a fourth embodiment of the position sensor 37. In such embodiment, a range finder or distance measurer 37 disposed on upper blade guard 42 can be used to determine the distance between blade 43, upper blade guard 42, base assembly 10 and/or table assembly 20. Persons skilled in the art will recognize that distance measurer 37 may be a laser distance measurer, an acoustic distance measure, an infrared distance measurer and/or a machine vision system. Persons skilled in the art will recognize that distance measurer 37 may be disposed alternatively on arm 41, support housing 30, base assembly 10 and/or table assembly 20.

FIG. 8 illustrates a fifth embodiment of the position sensor 38. In such embodiment, a lower blade guard 44′ is pivotally attached to upper blade guard 42. Lower blade guard 44′ preferably has an opening between two side walls.

With such arrangement, as blade 43 is moved towards base assembly 10 and/or table assembly 20 during a cutting operation, lower blade guard 44′ would contact a workpiece W placed on base assembly 10 and/or table assembly 20. Lower blade guard 44′ would be pushed towards upper blade guard 42, exposing blade 43 and allowing contact between blade 43 and workpiece W. As the blade 43 is moved further towards base assembly 10 and/or table assembly 20, blade 43 would continue to cut workpiece W. Workpiece W would continue contacting lower blade guard 44′, moving lower blade guard 44′ further upwardly relative to upper blade guard 42.

A rotational sensor 38 connected to lower blade guard 44′ can determine the rotational position of lower blade guard 44′ relative to upper blade guard 42, and provide a signal according to such rotational position to motor controller 51. Such signal would represent the position of the blade 43 with respect to workpiece W and/or lower blade guard 44′.

As shown in FIG. 9, motor controller 51 can set a maximum motor speed according to the position of arm 41 (and thus of blade 43) relative to the table assembly 20 and/or base assembly 10. For example, for a 12 inch miter saw, when the arm 41 is in the maximum angle relative to the table assembly 20 and/or base assembly 10, motor controller 51 may limit the motor speed to around 1500 rpm. As the user brings saw assembly 40 (and thus arm 41 and blade 43) downwardly towards the workpiece W, the table assembly 20 and/or base assembly 10, motor controller 51 increases the maximum motor speed, such as around 3600 rpm. This maximum motor speed may be achieved when the angle relative to the table assembly 20 and/or base assembly 10 is between around 55 degrees and around 0 degrees, and preferably between around 55 degrees and around 5 degrees.

Persons skilled in the art will recognize that a workpiece W placed on the table assembly 20 and/or base assembly 10 would be cut during this downward movement. During such cutting operation, the blade speed (and thus the motor speed) will drop from the pre-cutting motor speed, possibly down to about 1500 rpm.

As the user moves saw assembly 40 (and thus arm 41 and blade 43) upwardly away from the workpiece W, the table assembly 20 and/or base assembly 10, it is preferable to not increase the speed of motor 45 (and of blade 43) to the maximum motor speed or pre-cutting motor speed, as with a prior art miter saw, as such energy would be wasted if the user turns off motor 45 when saw assembly 40 (and thus arm 41 and blade 43) arrives at the top position of the saw assembly 40, i.e., when at the maximum angle relative to the table assembly 20 and/or base assembly 10. In order to minimize such wasted energy (and thus maximize battery run time), motor controller 51 can be programmed to delay the acceleration of motor 45 (and of blade 43) so that it only begins after saw assembly 40 has passed a predetermined angular threshold, such as about 40 degrees, in the upward direction while the user is still activating/pressing switch 45S.

Preferably, motor controller 51 will delay the acceleration of motor 45 (and of blade 43) until two events have occurred: (1) saw assembly 40 has passed a predetermined angular threshold, such as about 40 degrees or the top position of saw assembly 40, in the upward direction while the user is still activating/pressing switch 45S, and then (2) the user moves saw assembly 40 (and thus arm 41 and blade 43) downwardly towards the workpiece W, the table assembly 20 and/or base assembly 10, past a second threshold, such as when the arm angle relative to the table assembly 20 and/or base assembly 10 is between around 55 degrees. After both of these events have occurred, motor controller 51 would then increase motor speed (and thus blade speed).

Persons skilled in the art will recognize that motor controller 51 can recognize the movement direction of saw assembly 40 by comparing the signal received from the position sensors 32/33, 34135, 36, 37, 38 with the previous received signal. Motor controller 51 would use that directional information to determine the maximum motor speed for the present position of saw assembly 40, as discussed above. For example, if position sensor 32/33 is set up so that the signal has a lower voltage (due to increased resistance) as the saw assembly 40 is moved towards table assembly 20 and/or base assembly 10, motor controller 51 will recognize that saw assembly 40 is moving upwardly if the previous signal is lower than the most recent signal. Conversely motor controller 51 will recognize that saw assembly 40 is moving downwardly if the previous signal is higher than the most recent signal.

Similarly, if position sensor 34/35 is set up so that switch 34A will be closed at the lowest position, with switches 34B, 34C being at greater angles, motor controller 51 will recognize that saw assembly 40 is moving upwardly if the previous signal identifies switch 34A as pressed and the most recent signal identifies switch 34B as pressed, for example. Conversely motor controller 51 will recognize that saw assembly 40 is moving downwardly if the previous signal identifies switch 34B as pressed and the most recent signal identifies switch 34A as pressed, for example.

Persons skilled in the art will recognize that some encoders provide directional information. It is preferable to use such encoders as position sensor 36, so that motor controller 51 can receive and use the directional information.

In the embodiment of FIG. 7, position sensor 37 will provide a signal representative of the distance. Motor controller 51 will recognize that saw assembly 40 is moving upwardly if the previous signal represents a shorter distance than the most recent signal. Conversely motor controller 51 will recognize that saw assembly 40 is moving downwardly if the previous signal represents a longer distance than the most recent signal.

In the embodiment of FIG. 8, position sensor 38 will provide a signal representative of the rotational position of the lower blade guard 44′ relative to the blade 43 (and to workpiece W). If position 38 is set up so that a larger amplitude in the signal represents a larger rotational position of lower blade guard 44′, i.e., a shorter distance between the lower blade guard 44′ and upper blade guard 42, then motor controller 51 will recognize that saw assembly 40 is moving upwardly if the previous signal has a larger amplitude than the most recent signal. Conversely motor controller 51 will recognize that saw assembly 40 is moving downwardly if the previous signal has a smaller amplitude than the most recent signal.

Persons skilled in the art will recognize that it may also be beneficial for motor controller 51 to engage a braking circuit and/or a regenerative charging circuit 45B at the lowest position and/or as the user is moving saw assembly 40 upwardly. In particular, it is especially advantageous to engage the regenerative charging circuit 45B in order to charge battery pack 46 as the blade 43 coasts down to extend the number of cuts chop saw 100 can make before having to remove battery pack 46 for charging.

The description of the invention is merely exemplary in nature and, thus, variations that do not depart from the gist of the invention are intended to be within the scope of the invention. Such variations are not to be regarded as a departure from the scope of the invention.

What is claimed is:

1. A chop saw comprising:
a base assembly;
a support housing connected to the base assembly;
a saw assembly pivotally connected to the support housing allowing the saw assembly to be pivoted downwardly towards the base assembly for conducting a cutting operation on a workpiece, the saw assembly comprising a motor, a blade driven by the motor and an upper blade guard for covering an upper portion of the blade;
a sensor assembly disposed on at least one of the support housing and the saw assembly for sensing a position of the saw assembly relative to at least one of the workpiece and the support housing; and
a controller connected to the sensor assembly and the motor, the controller receiving an input representative of the position of the saw assembly and controlling the motor according to such input.

2. The chop saw of claim 1, wherein the sensor assembly comprises a resistive element disposed on the one of the support housing and the saw assembly, and a wiper contacting the resistive element, the wiper being disposed on the other of the support housing and the saw assembly.

3. The chop saw of claim 1, wherein the sensor assembly comprises a plurality of switches disposed on the one of the support housing and the saw assembly, and a protrusion contacting at least one of the switches, the protrusion being disposed on the other of the support housing and the saw assembly.

4. The chop saw of claim 1, wherein the sensor assembly comprises a rotary encoder disposed on the one of the support housing and the saw assembly, the rotary encoder comprising an axle connected to the other of the support housing and the saw assembly.

5. The chop saw of claim 1, wherein the sensor assembly comprises a distance measurer disposed on the upper blade guard.

6. The chop saw of claim 1, wherein the saw assembly further comprises a lower blade guard pivotally attached to the upper blade guard, and the sensor assembly senses a pivotal position of the lower blade guard relative to the upper blade guard.

7. The chop saw of claim 1, wherein the controller controls speed of the motor according to such input.

8. The chop saw of claim 7, wherein the controller increases the motor speed when the saw assembly is pivoted downwardly.

9. The chop saw of claim 8, wherein the controller increases the motor speed when the saw assembly is pivoted downwardly past a first angular threshold.

10. The chop saw of claim 7 wherein the controller decreases the motor speed when the saw assembly is pivoted upwardly.
